(19) United States
(12) Patent Application Publication
(10) Pub. No.: US 2020/0106344 A1
(43) Pub. Date: Apr. 2, 2020

(54) MOTOR UNIT

(71) Applicant: NIDEC TOSOK CORPORATION, Kanagawa (JP)

(72) Inventor: Yoshihisa OKUHATA, Kanagawa (JP)

(73) Assignee: NIDEC TOSOK CORPORATION, Kanagawa (JP)

(21) Appl. No.: 16/581,763

(22) Filed: Sep. 25, 2019

(30) Foreign Application Priority Data
Sep. 28, 2018 (JP) 2018-183272

(51) Int. Cl. H02K 9/193; H02K 7/00; H02K 11/33; B60K 11/04; B60K 1/00

(52) U.S. Cl. CPC H02K 9/193; H02K 7/006; B60K 2001/003; B60K 11/04; B60K 1/00; H02K 11/33

(57) ABSTRACT

A small-sized motor unit capable of cooling an inverter that drives a motor is provided. The motor unit includes: a motor that has a motor shaft disposed along a central axis that extends in an axial direction; a motor driving inverter that drives the motor; a first pump that is attached to the motor and supplies a first refrigerant for cooling the motor to the motor; and a second pump that is attached to the motor driving inverter and supplies a second refrigerant for cooling the motor driving inverter to the motor driving inverter.

### CROSS-REFERENCE TO RELATED APPLICATION

This application claims the priority benefit of Japan application serial no. 2018-183272, filed on Sep. 28, 2018. The entirety of the above-mentioned patent application is hereby incorporated by reference herein and made a part of this specification.

### BACKGROUND

### Technical Field

The disclosure relates to a motor unit.

### Description of Related Art

In the related art, technologies for cooling a motor are known. For example, Japanese Patent No. 5911033 discloses a rotating electric machine capable of cooling a stator and a rotor concurrently by causing a refrigerant to flow through both the stator and the rotor concurrently.

Incidentally, an inverter is required to drive a motor. An amount of heat generated by the inverter is large and cannot be ignored. Therefore, it is desirable to cool the inverter along with the motor.

However, cooing of the inverter is not taken into consideration in Japanese Patent No. 5911033 at all, and there is a problem that the inverter cannot be cooled. Therefore, an additional component for cooling the inverter is required to cool the inverter, and there is a problem that a configuration for driving the motor may increase in size.

### SUMMARY

There is provided a small-sized motor unit capable of cooling an inverter that drives a motor.

According to a first illustrative embodiment of the disclosure, there is provided a motor unit including: a motor that has a motor shaft disposed along a central axis that extends in an axial direction; a motor driving inverter that drives the motor; a first pump that is attached to the motor and supplies a first refrigerant for cooling the motor to the motor; and a second pump that is attached to the motor driving inverter and supplies a second refrigerant for cooling the motor driving inverter to the motor driving inverter.

According to the first illustrative embodiment of the disclosure, it is possible to provide a small-sized motor unit capable of cooling an inverter that drives a motor.

### BRIEF DESCRIPTION OF THE DRAWINGS

FIG. 1 is an outline perspective view of a motor unit according to a first embodiment of the disclosure.

FIG. 2 is a block diagram illustrating a state in which the motor unit 1 in FIG. 1 is mounted in a vehicle.

FIG. 3 is an outline side view of the motor unit 1 in FIG. 1 when seen from the other side in an axial direction.

FIG. 4 is an outline perspective view of a motor unit according to a second embodiment of the disclosure.

### DESCRIPTION OF EMBODIMENTS

Hereinafter, a motor unit according to embodiments of the disclosure will be described with reference to drawings. Although a motor unit that includes a traction motor for causing a vehicle to travel will be described in the embodiments, the disclosure is not limited thereto and can be applied to any motor. Also, the scaling, the numbers, and the like of the respective structures may be different from those of actual structures in the following drawings for ease of understanding of the respective configurations.

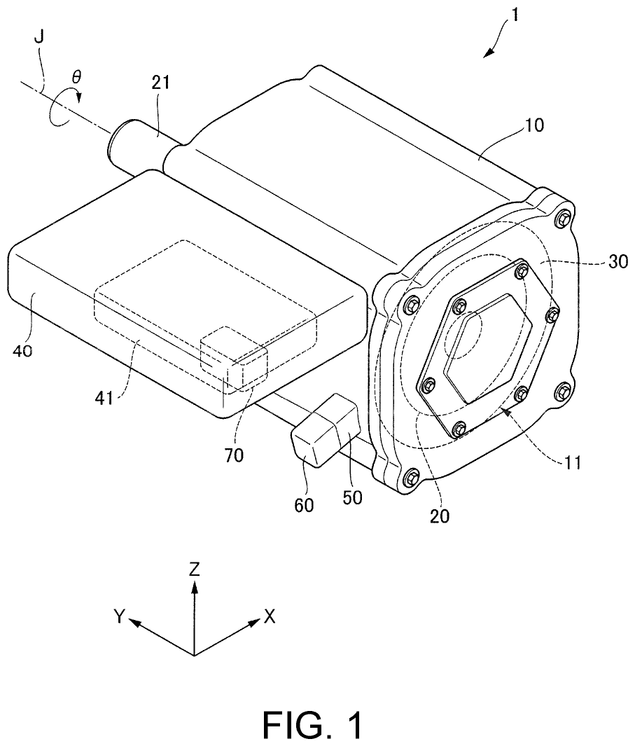

Also, XYZ coordinate systems will be appropriately illustrated as three-dimensional orthogonal coordinate systems in the drawings. In each XYZ coordinate system, the Z-axis direction is a vertical direction Z with a positive side being upward and with a negative side being downward as illustrated in FIG. 1. Also, the positive side in the vertical direction Z will be referred to as “one side in the vertical direction”, and the negative side in the vertical direction Z will be referred to as “the other side in the vertical direction”. The Y-axis direction is a direction that is parallel to a central axis J extending in one direction illustrated in FIG. 1 and that is perpendicular to the vertical direction Z. In the following description, the direction parallel to the central axis J, that is, the Y-axis direction will be referred to as an “axial direction Y”. In addition, the positive side in the axial direction Y will be referred to as “one side in the axial direction”, and the negative side in the axial direction Y will be referred to as “the other side in the axial direction”. The X-axis direction is a direction that is perpendicular to both the axial direction Y and the vertical direction Z. In the following description, the X-axis direction will be referred to as a “width direction X”. Also, the positive side in the width direction X will be referred to as “one side in the width direction”, and the negative side in the width direction X will be referred to as “the other side in the width direction”. In the embodiment, the vertical direction Z corresponds to a predetermined direction.

Also, a radial direction around the central axis J will be simply referred to as a “radial direction”, and a circumferential direction around the central axis J will be referred to as a “circumferential direction θ”. In addition, the clockwise advancing side when seen from the other side in the axial direction to one side in the axial direction in the circumferential direction θ, that is, the advancing side of the arrow representing the circumferential direction θ in the drawing will be referred to as “one side in the circumferential direction”, and the counterclockwise advancing side, that is, the side opposite to the advancing side of the arrow representing the circumferential direction θ in the drawing will be referred to as “the other side in the circumferential direction”.

Also, the vertical direction, upward, and the downward are names for simply explaining a relative positional relationship of the respective parts, and an actual disposition relationship or the like may be a disposition relationship or the like other than the disposition relationship represented by these names. In addition, directions such as forward, backward, left, right, upward, and downward in the specification represent directions when seen in the drawings and are not intended to limit directions when the device according to the disclosure is used.

Also, extending in the X-axis direction, the Y-axis direction, or the Z-axis direction in the specification includes extending in a direction inclined within a range of less than 45° relative to the X-axis direction, the Y-axis direction, or the Z-axis direction in addition to extending strictly in the X-axis direction, the Y-axis direction, or the Z-axis direction.

### First embodiment

### Overall configuration

FIG. 1 is an outline perspective view of a motor unit according to a first embodiment. As illustrated in FIG. 1, a motor unit 1 according to an embodiment includes a housing 10, a motor 11 that is accommodated in the housing 10, an inverter accommodation unit 40, a motor driving inverter 41 that is accommodated in the inverter accommodation unit 40, an electric oil pump 50, an oil cooler 60, and an electric water pump 70. The shapes of these respective components are not limited to those illustrated in FIG. 1.

The housing 10 accommodates the motor 11. Although the inverter accommodation unit 40 and the housing 10 are separate parts in the embodiment, the inverter accommodation unit 40 may be the same part as the housing 10. If the inverter accommodation unit 40 and the housing 10 are the same part, it is possible to further reduce the size of the motor unit 1.

Although the electric oil pump 50 is provided outside the housing 10 in the embodiment, the electric oil pump 50 may be provided inside the housing 10. It is possible to further reduce the size of the motor unit 1 by providing the electric oil pump 50 in the housing 10. The electric oil pump 50 is attached to the motor 11.

Although the oil cooler 60 is provided outside the housing 10 in the embodiment, the oil cooler 60 may be provided inside the housing 10. It is possible to further reduce the size of the motor unit 1 by providing the oil cooler 60 in the housing 10. The oil cooler 60 is attached to the electric oil pump 50. Therefore, it is possible to eliminate piping for oil between the oil cooler 60 and the electric oil pump 50.

Although the electric water pump 70 is provided outside the housing 10 in the embodiment, the electric water pump 70 may be provided inside the housing 10. It is possible to further reduce the size of the motor unit 1 by providing the electric water pump 70 in the housing 10.

Although the electric water pump 70 is provided outside the inverter accommodation unit 40 in the embodiment, the electric water pump 70 may be provided inside the inverter accommodation unit 40. It is possible to further reduce the size of the motor unit 1 by providing the electric water pump 70 in the inverter accommodation unit 40. The electric water pump 70 is attached to the motor driving inverter 41. Therefore, it is possible to eliminate piping for cooling water between the electric water pump 70 and the motor driving inverter 41.

The electric water pump 70 is disposed in the vicinity of the oil cooler 60. Since the electric water pump 70 is disposed in the vicinity of the oil cooler 60, it is possible to shorten the length of the piping for oil between the electric water pump 70 and the oil cooler 60.

The motor 11 has a motor shaft 21 that is disposed along the central axis J extending in the axial direction, a rotor 20 that is provided on the side outward from the motor shaft 21 in the radial direction and is able to rotate along with the motor shaft 21, and a stator 30 that is disposed on the side outward from the rotor 20 in the radial direction with a gap therebetween. The motor 11 generates heat with driving. The electric oil pump 50 supplies an oil that is a refrigerant for cooling the motor 11 to the motor 11. Specifically, the oil that serves as a refrigerant is circulated through a circulation route in the electric oil pump 50, the oil cooler 60, and the housing 10 by driving the electric oil pump 50. It is possible to cool the motor 11 while performing lubrication in the driving of the motor 11 by the refrigerant to be circulated by the electric oil pump 50 being an oil.

The inverter accommodation unit 40 accommodates the motor driving inverter 41. The motor driving inverter 41 drives the motor 11. The motor driving inverter 41 generates heat with driving of the motor 11. The electric water pump 70 supplies cooling water that serves as a refrigerant for cooling the motor driving inverter 41 to the motor driving inverter 41. Specifically, the cooling water that serves as a refrigerant is circulated through a circulation route in a radiator (not illustrated), the inverter accommodation unit 40, the electric water pump 70, and the oil cooler 60 by driving the electric water pump 70. Since the refrigerant circulated by the electric water pump 70 is, for example, cooling water, which is a coolant, it is possible to efficiently cool the motor driving inverter 41 with the cooling water cooled by the radiator.

The oil cooler 60 is a heat exchanger that performs heat exchange between the oil circulated by the electric oil pump 50 and the cooling water circulated by the electric water pump 70. The radiator is provided in the circulation route for the cooling water circulated by the electric water pump 70, and the cooling water is cooled by the radiator. The oil cooler 60 cools the oil circulated by the electric oil pump 50 with the cooled cooling water.

The motor unit 1 includes the electric oil pump 50, the electric water pump 70, and the oil cooler 60. Therefore, it is not necessary to separately prepare a water pump for cooling the motor driving inverter 41 and to provide a process for assembling the water pump in addition to a process for assembling the motor unit 1, and it is thus possible to reduce the number of processes for the assembly.

The electric oil pump 50 and the electric water pump 70 are electric pumps. Therefore, it is possible to improve cooling efficiency by performing electric drive control.

The motor unit 1 includes the oil cooler 60. It is possible to perform heat exchange between the cooling water and the oil with the oil cooler 60, to cool the oil with the oil cooler 60 by cooling the cooling water with the radiator, for example, and to reduce the number of assembly processes without any need to externally and separately provide a configuration for cooling the oil.

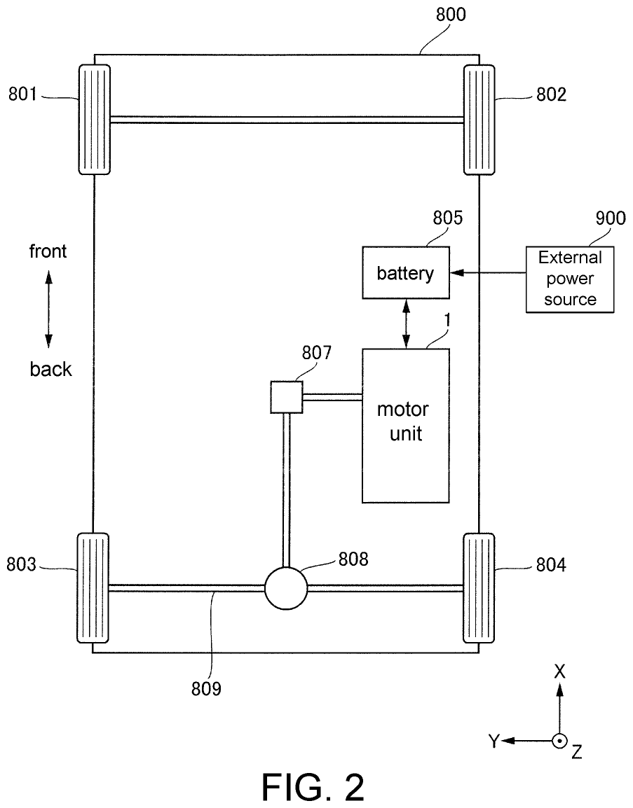

FIG. 2 is a block diagram illustrating a state in which the motor unit 1 in FIG. 1 is mounted in a vehicle. A vehicle 800 has a left front wheel 801, a right front wheel 802, a left rear wheel 803, a right rear wheel 804, the motor unit 1 illustrated in FIG. 1, a battery 805, a transmission 807, a differential gear 808, and a drive shaft 809. The vehicle 800 travels with the four wheels, namely the left front wheel 801, the right front wheel 802, the left rear wheel 803, and the right rear wheel 804.

A DC voltage generated by the battery 805 is transformed into a three-phase AC voltage by the motor driving inverter 41 and is supplied to the motor 11, thereby rotating the motor 11. The rotation of the motor 11 is delivered to the left rear wheel 803 and the right rear wheel 804 via the transmission 807, the differential gear 808, and the drive shaft 809. Although FIG. 2 illustrates an example of rear wheel drive, the vehicle 800 may be of a front wheel drive type or four-wheel drive type.

An external power source 900 is a charging stand, for example. The battery 805 is charged with a voltage from the external power source 900 via a charging inverter (not illustrated) by connecting the charging inverter to the external power source 900 when the vehicle 800 is parked, for example. The charging inverter has a charger (not illustrated) for charging the battery 805.

The respective components illustrated in FIG. 2 are operated under control by an electronic control unit (ECU) (not illustrated) mounted in the vehicle 800.

As can be understood with reference to FIGS. 1 and 2, the electric oil pump 50, the electric water pump 70, and the oil cooler 60 are disposed behind (−X side) the motor 11 when the advancing direction of the vehicle 800 is assumed to be forward (+X direction). Due to this point, it is possible to keep the piping for the refrigerant for the electric oil pump 50, the electric water pump 70, and the oil cooler 60 away from an impact if there is any impact from the side in front (+X side) of the vehicle 800.

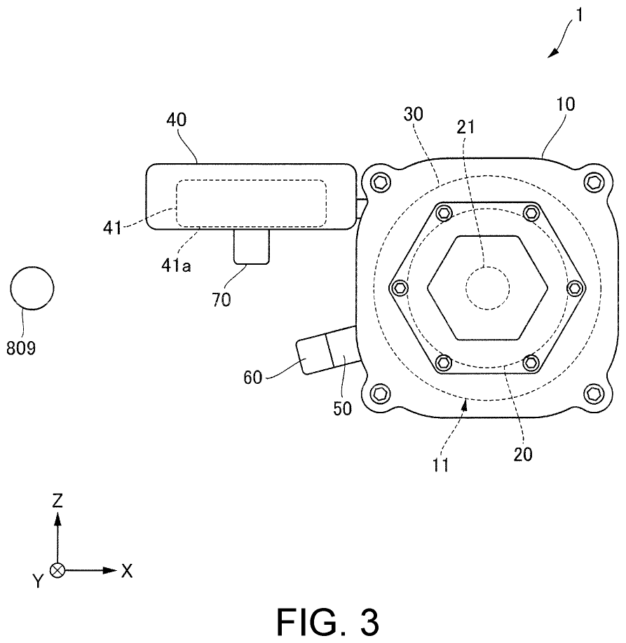

FIG. 3 is an outline side view of the motor unit 1 in FIG. 1 when seen from the other side in the axial direction. The electric water pump 70 is disposed on the side above (+Z side) the drive shaft 809. The electric oil pump 50 is disposed on the side below the drive shaft 809. In order to secure a minimum height of the vehicle 800 from the ground, the motor driving inverter 41 is disposed on the side above (+Z side) the drive shaft 809. In this case, it is possible to shorten the piping for the cooling water from the electric water pump 70 to the motor driving inverter 41 and to reduce a pressure loss due to a flow path length by disposing the electric water pump 70 on the side above the drive shaft 809. Also, a lower end (−z side end) of the motor 11 for causing the drive shaft 809 to rotate is disposed on the side below the drive shaft 809. In this case, it is possible to reduce a pressure loss caused when the oil remaining on the side (−Z side) below the motor 11 due to its own weight is circulated by the electric oil pump 50, by disposing the electric oil pump 50 on the side below the drive shaft 809.

The motor driving inverter 41 is disposed at a position at which at least a part thereof overlaps the motor 11 in a direction (X direction) parallel to the inverter bottom surface 41a on one side (+Z side) in a direction perpendicular to the inverter bottom surface 41a that is a bottom surface of the motor driving inverter 41. The electric oil pump 50, the electric water pump 70, and the oil cooler 60 are disposed at positions at which the motor driving inverter 41 and the motor 11 do not overlap in a direction (X direction) parallel to the inverter bottom surface 41a and at which the electric oil pump 50, the electric water pump 70, and the oil cooler 60 overlap the motor 11 on the other side (−Z side) in the direction perpendicular to the inverter bottom surface 41a.

It is possible to reduce the size of the motor unit 1 in the axial direction and the direction perpendicular to the axial direction by disposing the electric oil pump 50, the electric water pump 70, and the oil cooler 60 at positions at which the motor driving inverter 41 and the motor 11 do not overlap in the direction (X direction) parallel to the inverter bottom surface 41a. Also, it is possible to dispose the electric oil pump 50, the electric water pump 70, and the oil cooler 60 in the same vicinity, and thereby to eliminate or shorten the piping from the electric oil pump 50 to the oil cooler 60 and the piping from the electric water pump 70 to the oil cooler 60, and to reduce a pressure loss.

### Second Embodiment

### Overall Configuration

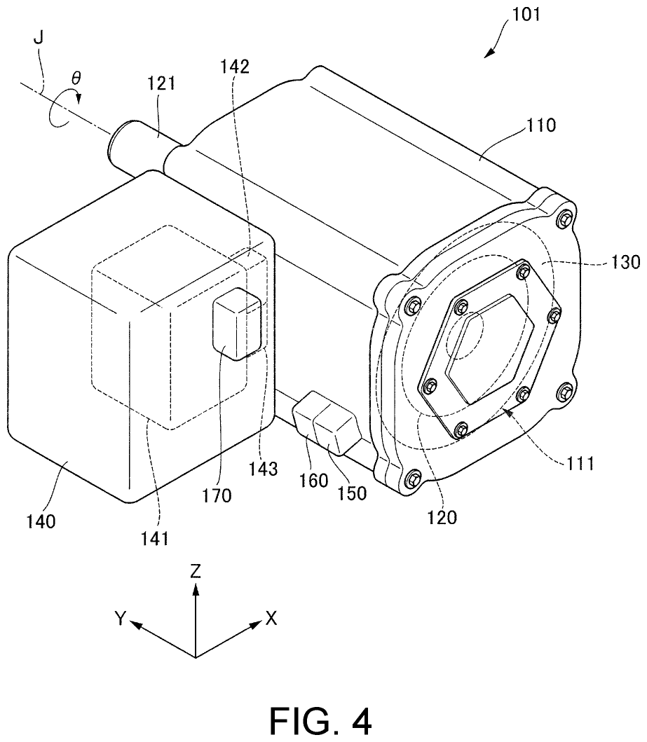

FIG. 4 is an outline perspective view of a motor unit according to a second embodiment. As illustrated in FIG. 4, a motor unit 101 according to the embodiment has a housing 110, a motor 111 that is accommodated in the housing 110, an inverter accommodation unit 140, a motor driving inverter 141 that is accommodated in the inverter accommodation unit 140, an electric oil pump 150, an oil cooler 160, and an electric water pump 170. Shapes of the respective components are not limited to those illustrated in FIG. 4.

The motor 111 has a motor shaft 121 that is disposed along a central axis J extending in the axial direction, a rotor 120 that is provided on the side outward from the motor shaft 121 in the radial direction and is able to rotate along with the motor shaft 121, and a stator 130 that is disposed on the side outward from the rotor 120 in the radial direction with a gap interposed therebetween. The motor 111 generates heat with driving. The electric oil pump 150 supplies an oil that serves as a refrigerant for cooling the motor 111 to the motor 111. Specifically, the oil that serves as a refrigerant is circulated through a circulation route in the electric oil pump 150, the oil cooler 160, and the housing 110 by driving the electric oil pump 150.

The inverter accommodation unit 140 accommodates the motor driving inverter 141. The motor driving inverter 141 drives the motor 111. The motor driving inverter 141 generates heat with driving of the motor 111. The electric water pump 170 supplies a cooling water that is a refrigerant for cooling the motor driving inverter 141 to the motor driving inverter 141. Specifically, the cooling water that serves as a refrigerant is circulated in a circulation route in the radiator (not illustrated), the inverter accommodation unit 140, the electric water pump 170, and the oil cooler 160 by driving the electric water pump 170.

The oil cooler 160 is a heat exchanger that performs heat exchange between the oil circulated by the electric oil pump 150 and the cooling water circulated by the electric water pump 170. There is a radiator in the circulation route of the cooling water circulated by the electric water pump 170, and the cooling water is cooled by the radiator. The oil cooler 160 cools the oil circulated by the electric oil pump 150 with the cooled cooling water.

The inverter accommodation unit 140 accommodates an electric oil pump driving inverter 143. The electric oil pump driving inverter 143 drives the electric oil pump 150. The inverter accommodation unit 140 accommodates an electric water pump driving inverter 142. The electric water pump driving inverter 142 drives the electric water pump 170.

The inverter accommodation unit 140 may accommodate at least either the electric oil pump driving inverter 143 or the electric water pump driving inverter 142. In this manner, it is possible to collectively dispose components that require piping, to reduce the size of the piping, and to reduce the number of assembly processes.

The motor driving inverter 141 is disposed at a position at which at least a part thereof overlaps the motor in the direction (X direction) perpendicular to the axial direction on one side (+Y side) in the axial direction. The electric oil pump 150, the electric water pump 170, and the oil cooler 160 are disposed at positions at which the motor driving inverter 141 and the motor 111 do not overlap in the direction (X direction) perpendicular to the axial direction and at which the electric oil pump 150, the electric water pump 170, and the oil cooler 160 overlap the motor 111 on the other side (−Y side) in the axial direction.

It is possible to reduce the size in the axial direction and the direction (X direction) perpendicular to the axial direction by arranging the electric oil pump 150, the electric water pump 170, and the oil cooler 160 at positions at which the motor driving inverter 141 and the motor 111 do not overlap in the direction (X direction) perpendicular to the axial direction. Also, it is possible to dispose the electric oil pump 150, the electric water pump 170, and the oil cooler 160 in the same vicinity, and thereby to eliminate or shorten the piping from the electric oil pump 150 to the oil cooler 160 and the piping from the electric water pump 170 to the oil cooler 160, and to reduce a pressure loss.

### Effects and Advantages of Motor Unit

Next, effects and advantages of the motor unit will be described.

(1) In the disclosure according to the aforementioned embodiment, the motor unit 1 includes the electric oil pump 50, the electric water pump 70, and the oil cooler 60. Therefore, it is not necessary to separately provide a water pump for cooling the motor driving inverter 41. Therefore, since it is not necessary to provide a process for assembling the water pump in addition to a process for assembling the motor unit 1, it is possible to reduce the number of assembly processes. Also, it is possible to provide a small-sized motor unit 1 capable of cooling the motor driving inverter 41 that drives the motor 11.

(2) In addition, the electric oil pump 50 and the electric water pump 70 are electric pumps. Therefore, it is possible to improve cooling efficiency by performing electric drive control.

(3) Also, the motor unit 1 includes an oil cooler 60. It is possible to perform heat exchange between the cooling water and the oil using the oil cooler 60, to cool the oil using the oil cooler 60 by cooling the cooling water using the radiator, for example, and to reduce the number of assembly processes without any need to externally and separately provide a configuration for cooling the oil.

(4) It is possible to reduce the size in the axial direction and the direction (X direction) perpendicular to the axial direction by disposing the electric oil pump 150, the electric water pump 170, and the oil cooler 160 at positions at which the motor driving inverter 141 and the motor 111 do not overlap in the direction (X direction) perpendicular to the axial direction. In addition, it is possible to dispose the electric oil pump 150, the electric water pump 170, and the oil cooler 160 in the same vicinity, and thereby to eliminate or shorten the piping from the electric oil pump 150 to the oil cooler 160 and the piping from the electric water pump 170 to the oil cooler 160, and to reduce a pressure loss.

(5) In addition, it is possible to reduce the size of the motor unit 1 in the axial direction and the direction perpendicular to the axial direction by disposing the electric oil pump 50, the electric water pump 70, and the oil cooler 60 at positions at which the motor driving inverter 41 and the motor 11 do not overlap in the direction (X direction) parallel to the inverter bottom surface 41a. Also, it is possible to dispose the electric oil pump 50, the electric water pump 70, and the oil cooler 60 in the same vicinity, and thereby to eliminate or shorten the piping from the electric oil pump 50 to the oil cooler 60 and the piping from the electric water pump 70 to the oil cooler 60, and to reduce a pressure loss.

(6) In addition, the electric oil pump 50, the electric water pump 70, and the oil cooler 60 are disposed behind (−X side) the motor 11 when the advancing direction of the vehicle 800 is assumed to be forward (+X direction). In this regard, it is possible to keep the piping for the refrigerant of the electric oil pump 50, the electric water pump 70, and the oil cooler 60 away from an impact if there is any impact from the side in front (+X side) of the vehicle 800.

(7) Also, the motor driving inverter 41 is disposed on the side above (+Z side) the drive shaft 809 in order to secure a minimum height of the vehicle 800 from the ground. In this case, it is possible to shorten the piping for the cooling water from the electric water pump 70 to the motor driving inverter 41 and to reduce a pressure loss due to the flow path length by disposing the electric water pump 70 on the side above the drive shaft 809. Also, the lower end (−Z side end) of the motor 11 for causing the drive shaft 809 to rotate is disposed on the side below the drive shaft 809. In this case, it is possible to reduce a pressure loss caused when the oil remaining on the side below (−Z side) the motor 11 due to its own weight is circulated by the electric oil pump 50 by disposing the electric oil pump 50 on the side below the drive shaft 809.

(8) In addition, the inverter accommodation unit 140 accommodates at least either the electric oil pump driving inverter 143 or the electric water pump driving inverter 142. Therefore, it is possible to collectively dispose components that require piping, to reduce the size of the piping, and to reduce the number of assembly processes.

(9) In addition, the refrigerant circulated by the electric oil pump 50 is an oil. In this regard, it is possible to cool the motor 11 while performing lubrication in driving of the motor 11. Also, the refrigerant circulated by the electric water pump 70 is, for example, cooling water, which is a coolant. In this regard, it is possible to efficiently cool the motor driving inverter 41 with the cooling water cooled by the radiator.

Applications of the motor unit according to the aforementioned embodiments are not particularly limited. The motor unit according to the aforementioned embodiments may be mounted in a vehicle, for example. Also, the aforementioned respective configurations can be appropriately combined within a range in which no contradiction occurs.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A motor unit comprising:
a motor that has a motor shaft disposed along a central axis that extends in an axial direction;
a motor driving inverter that drives the motor;
a first pump that is attached to the motor and supplies a first refrigerant for cooling the motor to the motor; and
a second pump that is attached to the motor driving inverter and supplies a second refrigerant for cooling the motor driving inverter to the motor driving inverter.

2. The motor unit according to claim 1, wherein the first pump and the second pump are electric pumps.

3. The motor unit according to claim 2, further comprising:
a heat exchanger that is attached to the motor and performs heat exchange between the first refrigerant and the second refrigerant.

4. The motor unit according to claim 3,
wherein the motor driving inverter in a direction perpendicular to the axial direction on one side in the axial direction is disposed at a position at which at least a part of the motor driving inverter overlaps the motor, and
the first pump, the second pump, and the heat exchanger are disposed at positions at which the motor driving inverter and the motor do not overlap in a direction perpendicular to the axial direction and at positions at which the first pump, the second pump, and the heat exchanger overlap the motor, on the other side in the axial direction.

5. The motor unit according to claim 3,
wherein the motor driving inverter is disposed at a position at which at least a part of the motor driving inverter overlaps the motor in a direction parallel to an inverter bottom surface, which is a bottom surface of the motor driving inverter, on one side in a direction perpendicular to the inverter bottom surface, and
the first pump, the second pump, and the heat exchanger are disposed at positions at which the motor driving inverter and the motor do not overlap in a direction parallel to the inverter bottom surface and at positions at which the first pump, the second pump, and the heat exchanger overlap the motor, on the other side in a direction perpendicular to the inverter bottom surface.

6. The motor unit according to claim 3,
wherein the motor is a motor that causes a drive shaft of a vehicle to rotate, and the first pump, the second pump, and the heat exchanger are disposed behind the motor when an advancing direction of the vehicle is assumed to be forward.

7. The motor unit according to claim 2,
wherein the motor is a motor that causes a drive shaft of a vehicle to rotate,
the second pump is disposed on a side above the drive shaft, and
the first pump is disposed on a side below the drive shaft.

8. The motor unit according to claim 2, further comprising:
an inverter accommodation unit that accommodates the motor driving inverter;
a first pump driving inverter that drives the first pump; and
a second pump driving inverter that drives the second pump,
wherein at least either the first pump driving inverter or the second pump driving inverter is accommodated in the inverter accommodation unit.

9. The motor unit according to claim 1,
wherein the first refrigerant is an oil, and
the second refrigerant is a cooling water.
